(19) United States
(12) Patent Application Publication
(10) Pub. No.: US 2021/0099324 A1
(43) Pub. Date: Apr. 1, 2021

(54) IOT GATEWAY FOR CONTROLLING DATA REPORTING INTERVAL OF IOT TERMINAL BASED ON DATA PREDICTION ACCURACY AND OPERATING METHOD THEREOF

(71) Applicant: Korea Advanced Institute of Science and Technology, Yuseong-gu (KR)

(72) Inventors: JunKyun Choi, Daejeon (KR); Jaeseob Han, Daejeon (KR)

(73) Assignee: Korea Advanced Institute of Science and Technology, Yuseong-gu (KR)

(21) Appl. No.: 16/987,021

(22) Filed: Aug. 6, 2020

(30) Foreign Application Priority Data
Sep. 30, 2019 (KR) 10-2019-0120296

(51) Int. Cl. H04L 12/66; G16Y 10/75; G06N 3/08; G06N 3/04

(52) U.S. Cl. CPC H04L 12/66; G06N 3/0445; G06N 3/08; G16Y 10/75

(57) ABSTRACT

Various example embodiments relate to an Internet of things (IoT) gateway for controlling a data transmission terminal of an IoT terminal based on data prediction accuracy and an operating method thereof, in which the IoT gateway may be configured to receive first data from the IoT terminal based on a first transmission interval, recover second data within the first transmission interval based on the first data, predict third data based on the first data and the second data using a predetermined machine learning scheme, and control the first transmission interval by comparing the first data and the third data.

This application claims the priority benefit of Korean Patent Application No. 10-2019-0120296, filed on Sep. 30, 2019, Korean Intellectual Property Office, the disclosure of which is incorporated herein by reference.

### BACKGROUND

### 1. Field of the Invention

Various example embodiments relate to an Internet of things (IoT) system and an operating method thereof, and more particularly, to an IoT gateway for controlling a data transmission interval of an IoT terminal based on data prediction accuracy and an operating method thereof.

### 2. Description of Related Art

Internet of things (IoT) technology refers to technology for implementing a valuable service using data collected from things attached with IoT terminals over a network. With the continuous development in such IoT technology, a number of IoT terminals arranged in various environments are on the gradual increase. The IoT terminals periodically transmit data. Here, data collected by the IoT terminals mostly include overlapping information or unnecessary information. Therefore, the IoT terminals use power to transmit data and accordingly, energy resources are unnecessarily used, which may lead to reducing the lifespan of the IoT terminals.

### SUMMARY

Various example embodiments provide an Internet of things (IoT) gateway that may prevent energy resources from being unnecessarily used when IoT terminals transmit data and may extend the lifespan of the IoT terminals and an operating method thereof.

Various example embodiments provide an IoT gateway that may reduce power used at IoT terminals by controlling a data transmission interval such that overlapping information or unnecessary information may be minimized in data transmitted from the IoT terminals, and an operating method thereof.

### Solutions

An Internet of things (IoT) system according to various example embodiments includes an IoT terminal configured to transmit first data based on a first transmission interval; and an IoT gateway configured to receive the first data from the IoT terminal, and to control the first transmission interval.

According to various example embodiments, the IoT gateway may be configured to recover second data within the first transmission interval based on the first data, predict third data based on the first data and the second data using a predetermined machine learning scheme, and control the first transmission interval by comparing the first data and the third data.

An IoT gateway according to various example embodiments may include a communication module configured to communicate with at least one IoT terminal; and a processor configured to receive data from the IoT terminal through the communication module and to process the data.

According to various example embodiments, the processor may be configured to receive first data from the IoT terminal based on a first transmission interval through the communication module, recover second data within the first transmission interval based on the first data, predict third data based on the first data and the second data using a predetermined machine learning scheme, and control the first transmission interval by comparing the first data and the third data.

An operating method of an IoT gateway according to various example embodiments may include receiving first data from an IoT terminal based on a first transmission interval; recovering second data within the first transmission interval based on the first data; predicting third data based on the first data and the second data using a predetermined machine learning scheme; and controlling the first transmission interval by comparing the first data and the third data.

According to various example embodiments, an Internet of things (IoT) gateway may control an interval at which data is transmitted from an IoT terminal based on accuracy of data predicted from the data transmitted from the IoT terminal. Through this, the IoT gateway may control the interval at which data is transmitted from the IoT terminal such that overlapping information or unnecessary information may be minimized in the data transmitted from the IoT terminal. Accordingly, the IoT gateway may collect necessary data from the IoT terminal while reducing power used by the IoT terminal. Therefore, it is possible to prevent energy resources from being unnecessarily used when the IoT terminal transmits data and to extend the lifespan of the IoT terminal. In addition, it is possible to reduce cost used to manage and analyze data using the IoT gateway.

### BRIEF DESCRIPTION OF DRAWINGS

FIG. 1 illustrates a structure of an Internet of things (IoT) system according to various example embodiments.

FIG. 2 illustrates an operating method of an IoT system according to various example embodiments.

FIG. 3 illustrates an internal configuration of an IoT terminal according to various example embodiments.

FIG. 4 illustrates an operating method of an IoT terminal according to various example embodiments.

FIG. 5 illustrates an internal configuration of an IoT gateway according to various example embodiments.

FIG. 6 illustrates an operating method of an IoT gateway according to various example embodiments.

FIGS. 7, 8A, 8B, 9, and 10 illustrate examples of describing an operating method of an IoT gateway according to various example embodiments.

### DETAILED DESCRIPTION

Hereinafter, various example embodiments of the present specification are described with reference to the accompanying drawings.

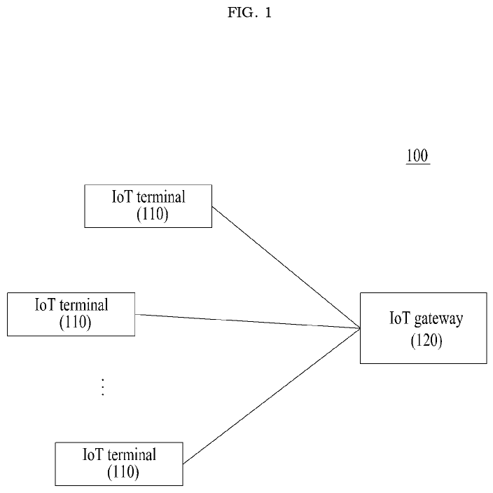

FIG. 1 illustrates a structure of an Internet of things (IoT) system 100 according to various example embodiments.

Referring to FIG. 1, the IoT system 100 according to various example embodiments may include a plurality of IoT terminals 110 and at least one IoT gateway 120. Each IoT gateway 120 may communicate with one or more IoT terminals 110 over a network. Here, the network may include a wireless network, for example, a near field wireless network.

The IoT terminals 110 may be attached to various types of objects, respectively, and collect a variety of data. Here, each of the IoT terminals 110 may transmit data to the IoT gateway 120 based on a preset transmission interval. That is, transmission intervals of the IoT terminals 110 may differ from each other.

The IoT gateway 120 may collect data from the IoT terminals 110. The IoT gateway 120 may control a transmission interval of each of at least one among the IoT terminals 110. Here, the IoT gateway 120 may be connected to an external device (not shown) in a wireless manner or a wired manner. The IoT gateway 120 may intermediate communication between the IoT terminals 110 and the external device. Here, the IoT gateway 120 may transfer the data collected from the IoT terminals 110 to the external device and may transfer a control instruction received from the external device to the IoT terminals 110.

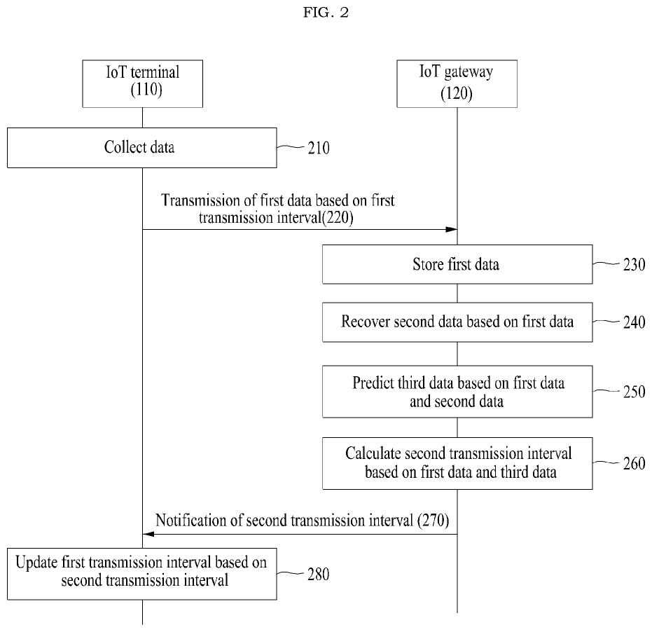

FIG. 2 illustrates an operating method of the IoT system 100 according to various example embodiments.

Referring to FIG. 2, in operation 210, each IoT terminal 110 may collect data. Here, each IoT terminal 110 may be attached to each corresponding object and may collect data. In operation 220, each IoT terminal 110 may transmit first data to the IoT gateway 120 based on a preset first transmission interval.

In operation 230, the IoT gateway 120 may store the first data. The IoT gateway 120 may receive the first data from each IoT terminal 110 based on the first transmission interval. Through this, the IoT gateway 120 may store the first data based on the first transmission interval.

In operation 240, the IoT gateway 120 may recover second data within the first transmission interval based on the first data. Here, the IoT gateway 120 may linearly recover the second data from the first data. Here, the IoT gateway 120 may linearly recover the second data from the first data by applying a linear interpolation. For example, the IoT gateway 120 may linearly recover the second data using the first data before and after each first transmission interval.

In operation 250, the IoT gateway 120 may predict third data based on the first data and the second data. Here, the IoT gateway 120 may predict the third data using a predetermined machine learning scheme. For example, the machine learning scheme may include a long-short term memory (LSTM) scheme.

In operation 260, the IoT gateway 120 may calculate a second transmission interval based on the first data and the third data. Here, the IoT gateway 120 may calculate the second transmission interval by comparing the first data and the third data. Through this, the IoT gateway 120 may calculate the second transmission interval based on prediction accuracy of the third data. For example, the IoT gateway 120 may calculate a difference value between the first data and the third data with respect to the same time. The IoT gateway 120 may calculate the second transmission interval based on the difference value. For example, the IoT gateway 120 may calculate the second transmission interval based on the difference value and a predetermined maximum transmission interval.

In operation 270, the IoT gateway 120 may notify each IoT terminal 110 of the second transmission interval. For example, the IoT gateway 120 may transmit a difference value between the first transmission interval and the second transmission interval to each IoT terminal 110.

In operation 280, the IoT terminal 110 may update the first transmission interval based on the second transmission interval. Here, the IoT terminal 110 may change a setting of the first transmission interval to correspond to the second transmission interval. For example, the IoT terminal 110 may adjust the first transmission interval by the difference value between the first transmission interval and the second transmission interval.

The IoT system 100 according to various example embodiments may include the IoT terminal 110 configured to transmit first data based on a first transmission interval and the IoT gateway 120 configured to receive the first data from the IoT terminal 110 and to control the first transmission interval.

According to various example embodiments, the IoT gateway 120 may be configured to recover second data within the first transmission interval based on the first data, to predict third data based on the first data and the second data using a predetermined machine learning scheme, and to control the first transmission interval by comparing the first data and the third data.

According to various example embodiments, the IoT gateway 120 may calculate a difference value between first data and third data with respect to the same time, may calculate a second transmission interval based on the difference value and a predetermined maximum transmission interval, and may notify the IoT terminal 110 of the second transmission interval.

According to various example embodiments, in response to the notification of the second transmission interval, the IoT terminal 110 may update the first transmission interval based on the second transmission interval.

According to various example embodiments, the machine learning scheme may include an LSTM scheme.

According to various example embodiments, the IoT gateway 120 may linearly recover the second data from the first data by applying a linear interpolation.

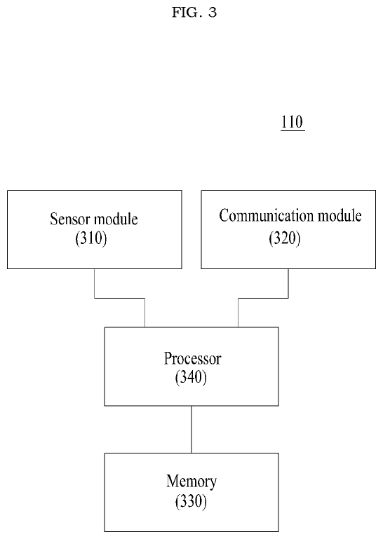

FIG. 3 illustrates an internal configuration of the IoT terminal 110 according to various example embodiments.

Referring to FIG. 3, the IoT terminal 110 according to various example embodiments may be attached to an object and may collect data, and may include at least one of a sensor module 310, a communication module 320, a memory 330, and a processor 340. In some example embodiments, at least one of components of the IoT terminal 110 may be omitted, or at least one another component may be added to the IoT terminal 110.

The sensor module 310 may generate data that indicates a state of the object to which the IoT terminal 110 is attached. The sensor module 310 may detect a state of the object from at least one of an internal environment or an external environment of the object.

The communication module 320 may support communication performance of the IoT terminal 110. The communication module 320 may establish a communication channel for the IoT terminal 110 and may perform communication through the communication channel. Here, the communication module 320 may include at least one of a wired communication module and a wireless communication module. For example, the wireless communication module may include at least one of a cellular communication module, a near field communication module, and a satellite communication module. Here, the communication module 320 may support communication performance between the IoT terminal 110 and the IoT gateway 120.

The memory 330 may store a variety of data used by at least one component of the IoT terminal 110. Data may include input data or output data about a program or an instruction related thereto. For example, the memory 330 may include at least one of a volatile memory and a nonvolatile memory.

The processor 340 may control at least one component of the IoT terminal 110 and may perform data processing or operation by executing a program of the memory 330. Here, the processor 340 may collect data through the sensor module 310. The processor 340 may transmit the first data to the IoT gateway 120 through the communication module 320, based on a first transmission interval preset for the IoT terminal 110. Also, the processor 340 may update the first transmission interval under control of the IoT gateway 120. Here, the processor 340 may receive a second transmission interval through the communication module 320, and may update the first transmission interval based on the second transmission interval.

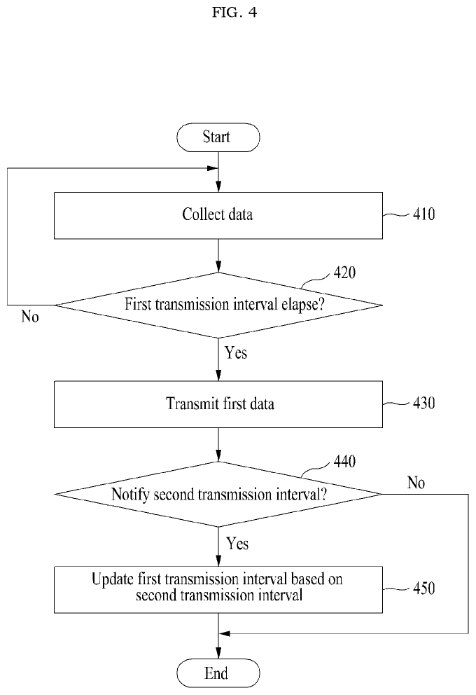

FIG. 4 illustrates an operating method of the IoT terminal 110 according to various example embodiments.

Referring to FIG. 4, in operation 410, the IoT terminal 110 may collect data. The IoT terminal 110 may be attached to an object and may collect data. Here, the processor 340 may collect the data through the sensor module 310. In response to the sensor module 310 sensing a state of the object from at least one of an internal environment and an external environment of the object, the processor 340 may collect data from the sensor module 310.

In operation 420, the IoT terminal 110 may detect elapse of a first transmission interval preset for the IoT terminal 110. That is, every time the first transmission interval elapses, the IoT terminal 110 may detect the elapse of the first transmission interval. In response thereto, the IoT terminal 110 may transmit first data to the IoT gateway 120 in operation 430. Here, the processor 340 may transmit the first data to the IoT gateway 120 through the communication module 320. Through this, the IoT terminal 110 may transmit the first data to the IoT gateway 120 based on the first transmission interval.

In operation 440, the IoT terminal 110 may receive notification of a second transmission interval from the IoT gateway 120. Here, the processor 340 may receive the second transmission interval through the communication module 320. For example, the processor 340 may receive a difference value between the first transmission interval and the second transmission interval. In response thereto, in operation 450, the IoT terminal 110 may update the first transmission interval based on the second transmission interval. Here, the processor 340 may change a setting of the first transmission interval to correspond to the second transmission interval. For example, the processor 340 may adjust the first transmission interval by the difference value between the first transmission interval and the second transmission interval. Through this, the IoT terminal 110 may update the first transmission interval under control of the IoT gateway 120.

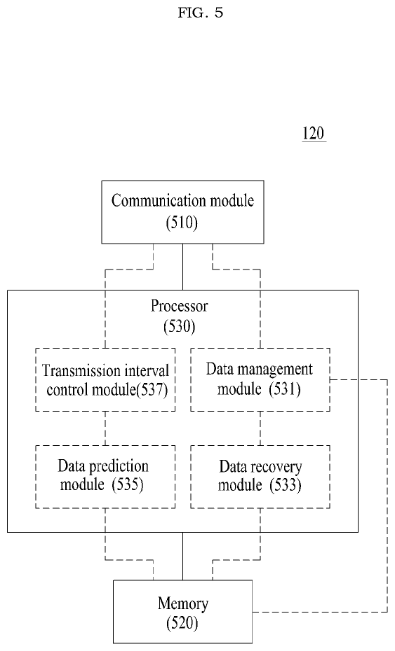

FIG. 5 illustrates an internal configuration of the IoT gateway 120 according to various example embodiments.

Referring to FIG. 5, the IoT gateway 120 according to various example embodiments may collect data from the IoT terminals 110 and may include at least one of a communication module 510, a memory 520, and a processor 530. Here, the IoT gateway 120 may control a transmission interval of each of at least one among the IoT terminals 110. In some example embodiments, at least one of components of the IoT gateway 120 may be omitted, or at least one another component may be added to the IoT gateway 120.

The communication module 510 may support communication performance of the IoT gateway 120. The communication module 510 may establish a communication channel for the IoT gateway 120 and may perform communication through the communication channel. Here, the communication module 510 may include at least one of a wired communication module and a wireless communication module. For example, the wireless communication module may include at least one of a cellular communication module, a near field communication module, and a satellite communication module. Here, the communication module 510 may support communication performance between the IoT gateway 120 and each IoT terminal 110.

The memory 520 may store a variety of data used by at least one component of the IoT gateway 120. Data may include input data or output data about a program or an instruction related thereto. For example, the memory 520 may include at least one of a volatile memory and a nonvolatile memory.

The processor 530 may control at least one component of the IoT gateway 120 and may perform data processing or operation by executing a program of the memory 520. Here, the processor 530 may receive data from each IoT terminal 110 through the communication module 510 and may process the data. The processor 530 may control a transmission interval under control of the IoT terminal 110. For example, the processor 530 may include at least one of a data management module 531, a data recovery module 533, a data prediction module 535, and a transmission interval control module 537.

The data management module 531 may receive first data from the IoT terminal 110 through the communication module 510. Here, the data management module 531 may receive the first data from the IoT terminal 110 based on a first transmission interval. The data management module 531 may store the first data in the memory 520.

The data recovery module 533 may restore second data within the first transmission interval based on the first data. Here, the data recovery module 533 may linearly recover the second data from the first data by applying a linear interpolation.

The data prediction module 535 may predict third data based on the first data and the second data. Here, the data prediction module 535 may predict the third data using a predetermined machine learning scheme. For example, the machine learning scheme may include an LSTM scheme.

The transmission interval control module 537 may control the first transmission interval by comparing the first data and the third data. Through this, the transmission interval control module 537 may calculate a second transmission interval based on prediction accuracy of the third data. Here, the transmission interval control module 537 may calculate a difference value between the first data and the third data with respect to the same time. The transmission interval control module 537 may calculate the second transmission interval based on the difference value. For example, the transmission interval control module 537 may calculate the second transmission interval based on the difference value and a predetermined maximum transmission interval. Also, the transmission interval control module 537 may control the IoT terminal 110 to update the first transmission interval based on the second transmission interval. To this end, the transmission interval control module 537 may notify the IoT terminal 110 of the second transmission interval through the communication module 510. For example, the transmission interval control module 537 may notify the IoT terminal 110 of a difference value between the first transmission interval and the second transmission interval.

The IoT gateway 120 according to various example embodiments may include the communication module 510 configured to communicate with at least one IoT terminal 110 and the processor 530 configured to receive data from the IoT terminal 110 through the communication module 510 and to process the data.

According to various example embodiments, the processor 530 may be configured to receive first data from the IoT terminal 110 based on a first transmission interval through the communication module 510, to recover second data within the first transmission interval based on the first data, to predict third data based on the first data and the second data using a predetermined machine learning scheme, and to control the first transmission interval by comparing the first data and the third data.

According to various example embodiments, the processor 530 may calculate a difference value between the first data and the third data with respect to the same time, may calculate a second transmission interval based on the difference value, and may control the IoT terminal 110 to update the first transmission interval based on the second transmission interval.

According to various example embodiments, the processor 530 may calculate the second transmission interval based on the difference value and a predetermined maximum transmission interval.

According to various example embodiments, the processor 530 may notify the IoT terminal 110 of the second transmission interval through the communication module 510.

According to various example embodiments, the IoT terminal 110 may transmit the first data based on the first transmission interval and may update the first transmission interval based on the second transmission interval in response to the notification of the second transmission interval.

According to various example embodiments, the processor 530 may notify the IoT terminal 110 of a difference value between the second transmission interval and the first transmission interval through the communication module 510.

According to various example embodiments, the machine learning scheme may include an LSTM scheme.

According to various example embodiments, the processor 530 may linearly recover the second data from the first data by applying a linear interpolation.

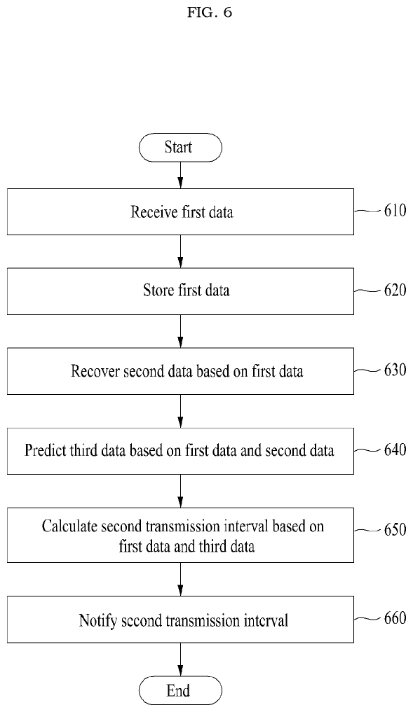

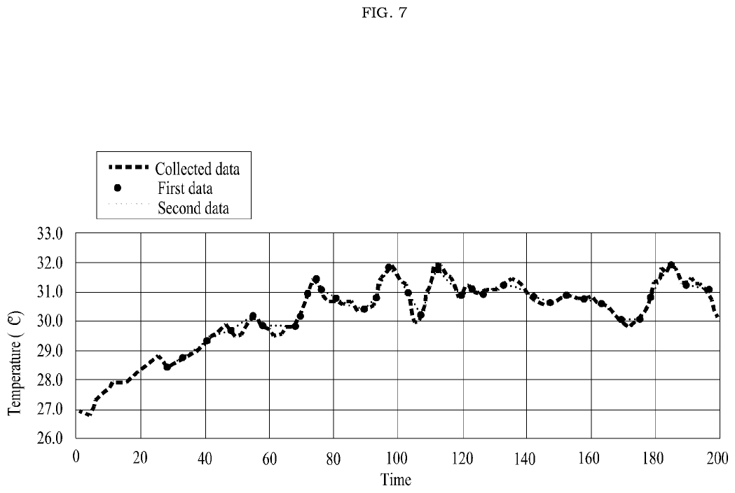

FIG. 6 illustrates an operating method of the IoT gateway 120 according to various example embodiments. FIGS. 7, 8A, 8B, 9, and 10 illustrate examples of describing an operating method of the IoT gateway 120 according to various example embodiments.

Referring to FIG. 6, in operation 610, the IoT gateway 120 may receive first data. The processor 530 may receive the first data from the IoT terminal 110 through the communication module 510. Here, the processor 530 may receive the first data from the IoT terminal 110 based on a first transmission interval. For example, the IoT terminal 110 may transmit the first data in collected data as illustrated in FIG. 7 and accordingly, the processor 530 may receive the first data.

In operation 620, the IoT gateway 120 may store the first data. The processor 530 may store the first data in the memory 520. Through this, the memory 520 may store the first data to correspond to the IoT terminal 110, based on the first transmission interval.

In operation 630, the IoT gateway 120 may recover second data within the first transmission interval based on the first data. Here, the processor 530 may linearly recover the second data from the first data. Here, the processor 530 may linearly recover the second data from the first data by applying a linear interpolation. For example, referring to FIG. 7, the processor 530 may linearly recover the second data using the first data before and after each first transmission interval. The second data may not be received from the IoT terminal 110 and may be linearly recovered from the first data by the processor 530 and thus, may not match data collected by the IoT terminal 110 as illustrated in FIG. 7.

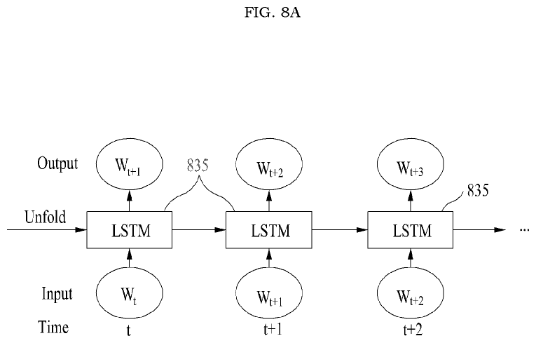

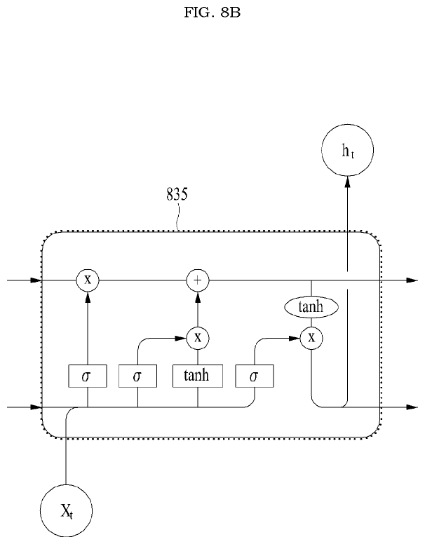

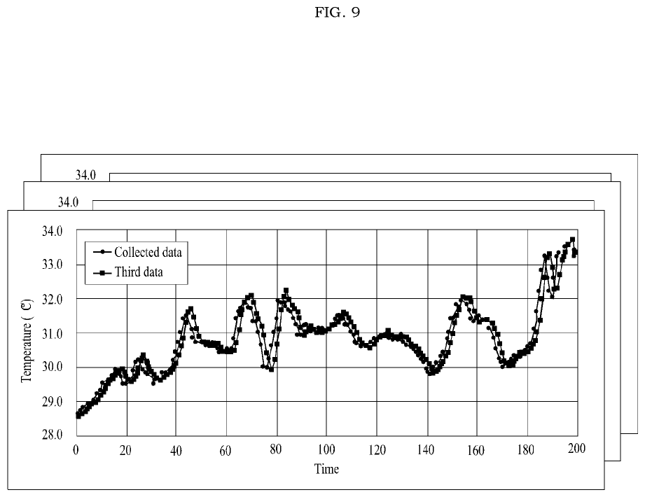

In operation 640, the IoT gateway 120 may predict third data based on the first data and the second data. Here, the processor 530 may predict the third data using a predetermined machine learning scheme. For example, the machine learning scheme may include an LSTM scheme. To this end, the processor 530, that is, the data prediction model 535 may include a plurality of LSTM cells 835 as illustrated in FIG. 8A and each LSTM cell 835 may be implemented as illustrated in FIG. 8B. Here, output from one of the LSTM cells 835 may be applied as input to another one of the LSTM cells 835. Third data may be predicted through a combination of outputs of the LSTM cells 835. According to the LSTM scheme, data of a time t+1 may be predicted based on data of a time t in the first data and the second data and data of a time t+2 may be predicted based on the data of the time t+1. In this manner, the third data may be predicted as illustrated in FIG. 9.

In operation 650, the IoT gateway 120 may calculate a second transmission interval based on the first data and the third data. Here, the processor 530 may calculate the second transmission interval by comparing the first data and the third data. Through this, the processor 530 may calculate the second transmission interval based on prediction accuracy of the third data. For example, the processor 530 may calculate a difference value R(t) between first data y(t) and third data ŷ(t) with respect to the same time t as represented as the following Equation 1. The processor 530 may calculate a second transmission interval T_{wait}(t) based on the difference value R(t) according to the following Equation 2. For example, the processor 530 may calculate the second transmission interval T_{wait}(t) based on the difference value R(t) and a predetermined maximum transmission interval Tₘₐₓ.

$$\begin{matrix}R ( t ) = \hat{y} ( t ) - y ( t ) & [ Equation 1 ] \\ {T}_{wait} ( t ) = ⌈ \frac{{T}_{max}}{1 + {\vert R ( t ) \vert}^{φ}} ⌉ & [ Equation 2 ]\end{matrix}$$

In operation 660, the IoT gateway 120 may notify the IoT terminal 110 of the second transmission interval. Here, the processor 530 may notify the IoT terminal 110 of the second transmission interval through the communication module 510. For example, the processor 530 may transmit a difference value between the first transmission interval and the second transmission interval to the IoT terminal 110.

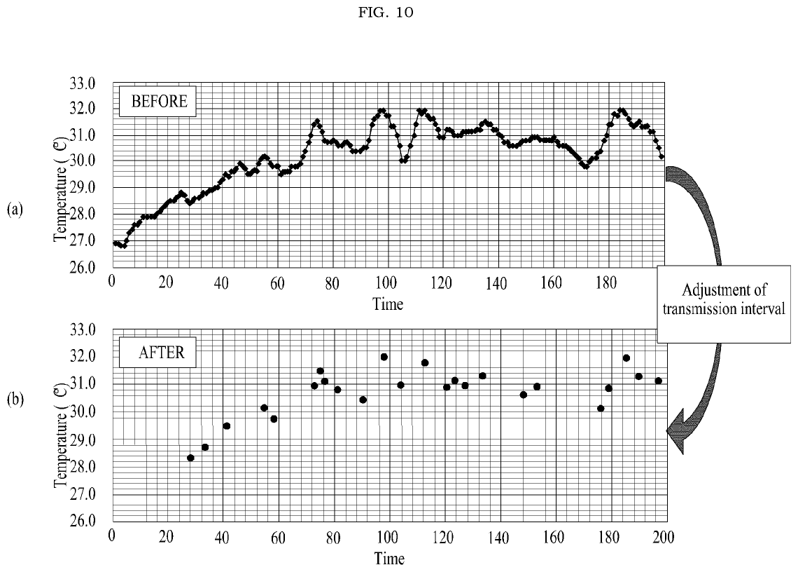

Through this, the IoT terminal 110 may update the first transmission interval based on the second transmission interval. Here, the IoT terminal 110 may change a setting of the first transmission interval to correspond to the second transmission interval. For example, if the first transmission interval is set as illustrated in (a) of FIG. 10, the IoT terminal 110 may adjust the first transmission interval by the difference value between the first transmission interval and the second transmission interval as illustrated in (b) of FIG. 10. Through this, the IoT terminal 110 may update the first transmission interval under control of the IoT gateway 120.

An operating method of the IoT gateway 120 according to various example embodiments may include receiving first data from the IoT terminal 110 based on a first transmission interval, recovering second data within the first transmission interval based on the first data, predicting third data based on the first data and the second data using a predetermined machine learning scheme, and controlling the first transmission interval by comparing the first data and the third data.

According to various example embodiments, the controlling of the first transmission interval may include calculating a difference value between the first data and the third data with respect to the same time, calculating a second transmission interval based on the difference value, and controlling the IoT terminal 110 to update the first transmission interval based on the second transmission interval.

According to various example embodiments, the calculating of the second transmission interval may include calculating the second transmission interval based on the difference value and a predetermined maximum transmission interval.

According to various example embodiments, the controlling of the IoT terminal 110 to update the first transmission interval may include notifying the IoT terminal 110 of the second transmission interval.

According to various example embodiments, the IoT terminal 110 may transmit the first data based on the first transmission interval and may update the first transmission interval based on the second transmission interval in response to the notification of the second transmission interval.

According to various example embodiments, the notifying of the second transmission interval may include notifying the IoT terminal 110 of a difference value between the second transmission interval and the first transmission interval.

According to various example embodiments, the machine learning scheme may include an LSTM scheme.

According to various example embodiments, the recovering of the second data may include linearly recovering the second data from the first data by applying a linear interpolation.

According to various example embodiments, the IoT gateway 120 may control an interval at which data is transmitted from the IoT terminal 110 based on accuracy of data predicted from the data transmitted from the IoT terminal 110. Through this, the IoT gateway 120 may control the interval at which data is transmitted from the IoT terminal 110 such that overlapping information or unnecessary information may be minimized in the data transmitted from the IoT terminal 110. Accordingly, the IoT gateway 120 may collect necessary data from the IoT terminal 110 while reducing power used by the IoT terminal 110. Therefore, it is possible to prevent energy resources from being unnecessarily used when the IoT terminal 110 transmits data and to extend the lifespan of the IoT terminal 110. In addition, it is possible to reduce cost used to manage and analyze data using the IoT gateway 120.

The various example embodiments and the terms used herein are not construed to limit the technique described herein to specific example embodiments and may be understood to include various modifications, equivalents, and/or substitutions. Like reference numerals refer to like elements throughout. As used herein, the singular forms “a,” “an,” and “the,” are intended to include the plural forms as well, unless the context clearly indicates otherwise. Herein, the expressions, “A or B,” “at least one of A and/or B,” “A, B, or C,” “at least one of A, B, and/or C,” and the like may include any possible combinations of listed items. Terms “first,” “second,” etc., are used to describe various components and the components should not be limited by the terms. The terms are simply used to distinguish one component from another component. When a component (e.g., a first component) is described to be “(functionally or communicatively) connected to” or “accessed to” another component (e.g., a second component), the component may be directly connected to the other component or may be connected through still another component (e.g., a third component).

The term “module” used herein may include a unit configured as hardware, software, or firmware, and may be interchangeably used with, for example, the terms “logic,” “logic block,” “part,” “circuit,” etc. The module may be an integrally configured part, a minimum unit that performs at least one function, or a portion thereof. For example, the module may be configured as an application-specific integrated circuit (ASIC).

Various example embodiments herein may be implemented as software that includes at least one instruction stored in a storage medium (e.g., the memory 520) readable by a machine (e.g., the IoT gateway 120). For example, a processor (e.g., the processor 530) of the machine may call at least one instruction from among the stored one or more instructions from the storage medium and may execute the called at least one instruction, which enables the machine to operate to perform at least one function according to the called at least one instruction. The at least one instruction may include a code generated by a compiler or a code executable by an interpreter. The machine-readable storage medium may be provided in a form of a non-transitory record medium. Here, “non-transitory” simply indicates that the record medium is a tangible device and does not include a signal (e.g., electromagnetic wave). This term does not distinguish a case in which data is semi-permanently stored and a case in which the data is temporarily stored in the record medium.

According to the various example embodiments, each component (e.g., module or program) of the aforementioned components may include a singular entity or a plurality of entities. According to the various example embodiments, at least one component among the aforementioned components or operations may be omitted, or at least one another component or operation may be added. Alternately or additionally, the plurality of components (e.g., module or program) may be integrated into a single component. In this case, the integrated component may perform the same or similar functionality as being performed by a corresponding component among a plurality of components before integrating at least one function of each component of the plurality of components. According to the various example embodiments, operations performed by a module, a program, or another component may be performed in parallel, repeatedly, or heuristically, or at least one of the operations may be performed in different order or omitted. Alternatively, at least one another operation may be added.

What is claimed is:

1. An operating method of an Internet of things (IoT) gateway, the method comprising:
receiving first data from an Internet of things (IoT) terminal based on a first transmission interval;
recovering second data within the first transmission interval based on the first data;
predicting third data based on the first data and the second data using a predetermined machine learning scheme; and
controlling the first transmission interval by comparing the first data and the third data.

2. The method of claim 1, wherein the controlling of the first transmission interval comprises:
calculating a difference value between the first data and the third data with respect to the same time;
calculating a second transmission interval based on the difference value; and
controlling the IoT terminal to update the first transmission interval based on the second transmission interval.

3. The method of claim 2, wherein the calculating of the second transmission interval comprises calculating the second transmission interval based on the difference value and a predetermined maximum transmission interval.

4. The method of claim 2, wherein the controlling of the IoT terminal to update the first transmission interval comprises notifying the IoT terminal of the second transmission interval.

5. The method of claim 4, wherein the IoT terminal is configured to transmit the first data based on the first transmission interval and to update the first transmission interval based on the second transmission interval in response to the notification of the second transmission interval.

6. The method of claim 4, wherein the notifying of the second transmission interval comprises notifying the IoT terminal of a difference value between the second transmission interval and the first transmission interval.

7. The method of claim 1, wherein the machine learning scheme includes a long-short term memory (LSTM) scheme.

8. The method of claim 1, wherein the recovering of the second data comprises linearly recovering the second data from the first data by applying a linear interpolation.

9. An Internet of things (IoT) gateway comprising:
a communication module configured to communicate with at least one IoT terminal; and
a processor configured to receive data from the IoT terminal through the communication module and to process the data,
wherein the processor is configured to
receive first data from the IoT terminal based on a first transmission interval through the communication module,
recover second data within the first transmission interval based on the first data,
predict third data based on the first data and the second data using a predetermined machine learning scheme, and
control the first transmission interval by comparing the first data and the third data.

10. The IoT gateway of claim 9, wherein the processor is configured to
calculate a difference value between the first data and the third data with respect to the same time,
calculate a second transmission interval based on the difference value, and
control the IoT terminal to update the first transmission interval based on the second transmission interval.

11. The IoT gateway of claim 10, wherein the processor is configured to calculate the second transmission interval based on the difference value and a predetermined maximum transmission interval.

12. The IoT gateway of claim 10, wherein the processor is configured to notify the IoT terminal of the second transmission interval through the communication module.

13. The IoT gateway of claim 12, wherein the IoT terminal is configured to transmit the first data based on the first transmission interval and to update the first transmission interval based on the second transmission interval in response to the notification of the second transmission interval.

14. The IoT gateway of claim 12, wherein the processor is configured to notify the IoT terminal of a difference value between the second transmission interval and the first transmission interval through the communication module.

15. The IoT gateway of claim 9, wherein the machine learning scheme includes a long-short term memory (LSTM) scheme.

16. The IoT gateway of claim 9, wherein the processor is configured to linearly recover the second data from the first data by applying a linear interpolation.

17. An Internet of things (IoT) system comprising:
an IoT terminal configured to transmit first data based on a first transmission interval; and
an IoT gateway configured to receive the first data from the IoT terminal, and to control the first transmission interval,
wherein the IoT gateway is configured to
recover second data within the first transmission interval based on the first data,
predict third data based on the first data and the second data using a predetermined machine learning scheme, and
control the first transmission interval by comparing the first data and the third data.

18. The IoT system of claim 17, wherein the IoT gateway is configured to
calculate a difference value between the first data and the third data with respect to the same time,
calculate a second transmission interval based on the difference value and a maximum transmission interval, and
notify the IoT terminal of the second transmission interval, and
the IoT terminal is configured to to update the first transmission interval based on the second transmission interval in response to the notification of the second transmission interval.

19. The IoT system of claim 17, wherein the machine learning scheme includes a long-short term memory (LSTM) scheme.

20. The IoT system of claim 17, wherein the IoT gateway is configured to linearly recover the second data from the first data by applying a linear interpolation.
